(19) United States
(12) Patent Application Publication
(10) Pub. No.: US 2022/0031074 A1
(43) Pub. Date: Feb. 3, 2022

(54) TWO COLOR PROCESS

(71) Applicant: Brian Moon, Sycamore, IL (US)

(72) Inventor: Brian Moon, Sycamore, IL (US)

(21) Appl. No.: 17/502,033

(22) Filed: Oct. 14, 2021

Related U.S. Application Data
(63) Continuation of application No. 16/436,914, filed on Jun. 10, 2019, now abandoned.
Application No. 16/436,914 is a continuation-in-part of application No. 62/683,013, filed on Jun. 10, 2018.
Application No. 62/683,013 is a continuation-in-part of application No. 16/132,425, filed on Sep. 16, 2018, now abandoned.
Application No. 16/132,425 is a continuation of application No. 62/561,202, filed on Sep. 20, 2017.

(51) Int. Cl. A47C 5/12; B29C 41/06; B32B 3/30; B29C 41/46

(52) U.S. Cl. CPC A47C 5/12; B29C 41/06; B29L 2031/443; B29C 41/46; B32B 2479/00; B32B 3/30

(57) ABSTRACT

The invention is a method of manufacturing a multi-color molded furniture item made by a multi-step molding process using heat zone control in the mold to apply different plastic charges to predefined portions of the mold. Controlling zones of the mold with heat by zone heating and thermal insulators separating mold zones for molding a part of different plastics differing in characteristics such as color, durability, surface finish and chemical resistance.

This application is a continuation of copending U.S. Non-Provisional Patent application Ser. No. 16/436,914, filed Jun. 19, 2019 which is a continuation in part of then pending U.S. Provisional Patent Application No. 62683013, filed Jun. 10, 2018, and a continuation in part of then pending U.S. patent application Ser. No. 16/132,425 filed Sep. 16, 2018 which is a continuation of then pending U.S. Provisional Patent Application No. 62561202, filed Sep. 20, 2017, the content of which is hereby incorporated by reference.

### FIELD OF THE INVENTION

The intensive use furniture relates generally to the manufacture of multi color molded furniture.

### BACKGROUND OF THE INVENTION

Molded furniture is designed for use in demanding environments having integrally formed features and minimizing removable parts. The furniture must be designed to prevent injury to the user, either intentional or not. The furniture may be formed by rotational or vacuum formed molding techniques known in the art. Molding furniture of plastic has meant parts typically are formed of one color base material. Other parts may be made of an alternate color and attached to the first part to form a two color piece of furniture. Alternatively, additional steps to form a multi color piece of molded furniture may be to paint or color a part to add an additional color or an aesthetic design to the finished molded furniture part.

Rotational molding is a manufacturing method used for producing hollow, plastic articles. Typical rotational molding processes utilize high temperatures, low pressures, and bi-axial rotation, to produce hollow, one-piece parts. Although rotational molding is particularly suited to producing hollow articles, the technique can provide shaped articles that compete effectively with other molding and extrusion processes, in particular, with extrusion blow molding.

Rotational molding differs from all other processing methods in that the heating, melting, shaping, and cooling stages all occur after the polymer is placed in the mold. In addition, no external pressure is used to force the molten polymer into the mold. Rotational molded products are essentially stress-free, have no weld lines, and can be produced in complex shapes. In addition, mold costs are relatively low, which allows large articles to be produced economically. Typical applications of rotational molded articles are toys, tanks, containers, boxes, ducts, furniture, automobile bumpers, light globes, etc.

The prior art teaches forming multi color plastic molded parts by the use of removable mechanical dividers placed in a mold to segment the mold interior. A first color plastic material is placed in a first mold segment. A second color plastic material is placed in a second mold segment and so on to charge the segments with different color plastic. The mold is heated to a desired temperature sufficient to melt the plastic while rotating the mold to bring the plastic material in contact with the heated mold thereby coating the interior of the mold segments with the respective colored plastic materials. However, the use of dividers may leave a blank in the skin of the part where the mechanical divider bears against the mold interior surface. The process also requires additional labor to to separate the mold to place and remove the dividers. Therefore, it is desirable to develop a method of manufacture to produce a two color furniture part without additional labor and steps.

### BRIEF SUMMARY OF THE INVENTION

The present multi color furniture article may be formed by a process of heat zone control in the mold interior to isolate predefined portions of the mold interior to form a multi color part in a single molding operation. The multi color furniture comprises a multi color skin having an integrally molded, multi color or aesthetic design formed thereon. A two step process for rotational molding of polymers may be utilized to form the multi color furniture part in a single cycle by isolating a first mold portion from a second mold portion with separate, isolated heat control in each mold portion and insulating barriers between each mold portion to thermally isolate the mold portion. This method may include charging a first plastic material resin into a hollow mold that is heated by zones having a first mold portion defining a first heat zone heated to a predetermined molding temperature while not heating a second molding zone. The second molding zone is maintained at a temperature below the predetermined molding temperature. The first plastic material bonds to the first mold portion and not the cooler, second mold portion. A thermal barrier may be disposed between the first mold portion forming a first heat zone and the second mold portion forming a second heat zone. The thermal barrier prevents heat from creeping or radiating from the first heat zone to the second heat zone, thereby raising the temperature of the second heat zone. The temperature zone control may comprise a plurality of heaters placed on the mold in separately controlled zones defined by the first mold portion representing the first heat zone and the second mold portion representing the second heat zone. The mold portions are thermally isolated by an insulator applied at a parting line where the mold portions mate to form a closed mold. Thermal isolation of the mold portions allows plastic resin in the mold to adhere and melt onto only the heated mold portion.

In a first step, a first heat zone is heated and a second heat zone is not heated. Plastic material, usually in the form of powder or granules having a first color is placed in the mold. The mold is rotated continuously in a uni-axial or bi-axial mode and the first heat zone heaters maintain the first mold portion at a predetermined temperature causing the plastic material to melt onto the heated mold portion to form a portion of the molded furniture article in a first color and a first plastic resin type. The plastic material is prevented from melting and coating the unheated second mold portion representing the second heat zone. In this first step, only the first portion of the mold, heated to a predetermined temperature, may cause the plastic resin to stick to the respective mold interior portion to melt into what will be an outer skin for the furniture article. In a second step, the second mold portion representing a second heat zone is heated by respective heaters. The second heat zone of the mold is heated to a second predetermined temperature and a second plastic material, having a second color is charged into the mold. The second plastic material may differ from the first plastic material. The mold continues to rotate along two or three axes until all the plastic material is melted and integrated into the furniture part. The second plastic material contacts the second mold portion and the coated first mold portion to coat the heated second mold portion interior surface forming a two color part. The rotation and heat are continued until the entire mold is coated forming the molded furniture part. The mold is gradually cooled causing the first plastic material and the second plastic material to harden in the shape of the interior walls of the mold forming the molded article of furniture having colored portions corresponding to the heat zones.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a front plan view of a mold having zone control heating elements.

FIG. 2 is a section view of the mold taken at approximately 2-2 of FIG. 1.

FIG. 3 is a perspective view of a foot rest formed with the two step color process.

FIG. 4 is a section view of the foot rest of FIG. 3 taken at approximately 4-4 of FIG. 3.

FIG. 5 is a perspective view of a mold with the top and bottom removed.

FIG. 6 is a perspective view of a mold bottom plate removed from the mold.

FIG. 7 is a perspective view of a mold top plate removed from the mold.

FIG. 8 is a perspective view of a french cleat support portion.

FIG. 9 is a top plan view of a logo mold.

FIG. 10 is a perspective view of a plug.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Referring to FIG. 1, mold 100 may have a first mold portion 102 and a second mold portion 104, a plurality of heating elements 106 and a drop box 114. First mold portion 102 may comprise a first mating surface 120 adapted to bear against second mating surface 122 on second mold portion 104. Insulator 130 is disposed between first mating surface 120 and second mating surface 122 to thermally isolate first mating surface from second mating surface thereby surrounding and closing mold cavity 118. Each of the plurality of heating elements 106 may be adapted to heat or cool an adjacent temperature zone 108 on mold 100. Each of the plurality of heating elements 106 may be an electrical element or a fluid dispenser to apply hot or cool liquid to its respective zone 108. Each of the plurality of heating elements 106 is disposed in a predetermined pattern with respect to each other and the mold 100. The predetermined pattern is adapted to create separate heat/cooling zones 108. The zones 108 will be discussed herein as heat zones for purpose of this discussion. It should be understood, the heating elements 106 may also be adapted to cool its respective zone 108. The first mold portion 102 may comprise a hollow interior forming first mold cavity 110 surrounded by the first mold portion 102. First mold cavity 110 comprises mold wall 107 and mold lip or first mating surface 120. First mold mating surface 120 may have insulator 130 thereon. Second mold portion 104 may comprise a hollow interior forming second mold cavity 112. Second mold portion 104 further comprises mold wall 109 and second lip or mating surface 122. Second mold mating surface 122 is adapted to bear against first mating surface 120. Second mold mating surface 122 and first mold mating surface 120 are adapted to sealingly bear against insulator 130 to enclose and hold first mold cavity 102 and second mold cavity 104 in fluid communication forming enclosed mold interior 118

Continuing to refer to FIG. 1, mold 100 may further comprise drop box 114 mounted on mold opening 119, Drop box 114 may comprise plastic holding chamber 115, dispenser valve 116 and lid 117. Drop box 114 may be attached to mold 100 at mold opening 119 whereby chamber 115 is in fluid communication with mold interior 118 when dispenser valve 116 is in an open position. Dispenser valve 116 is adapted to move from an open position to a closed position whereby chamber 115 is isolated from first mold cavity 118 when dispenser valve is in a closed position. Lid 117 closes drop box 114 to hold plastic material in chamber 115. Plastic material in the form of powder, granules or other predefined shape and size is placed in the hollow chamber 115. The lid 117 is closed to seal the hollow chamber 115. Dispenser valve 116 may be opened. In the open position, drop box 114 is in fluid communication with mold interior 118.

Continuing to refer to FIG. 1, control 150 may be connected to heating elements 114 and dispenser valve 116 by connector 152. Each heating element 106 may be adapted to heat or cool its particular zone 108. Side by side color design as shown in stool 200 may be formed using heat zone control with the mold of FIG. 1.

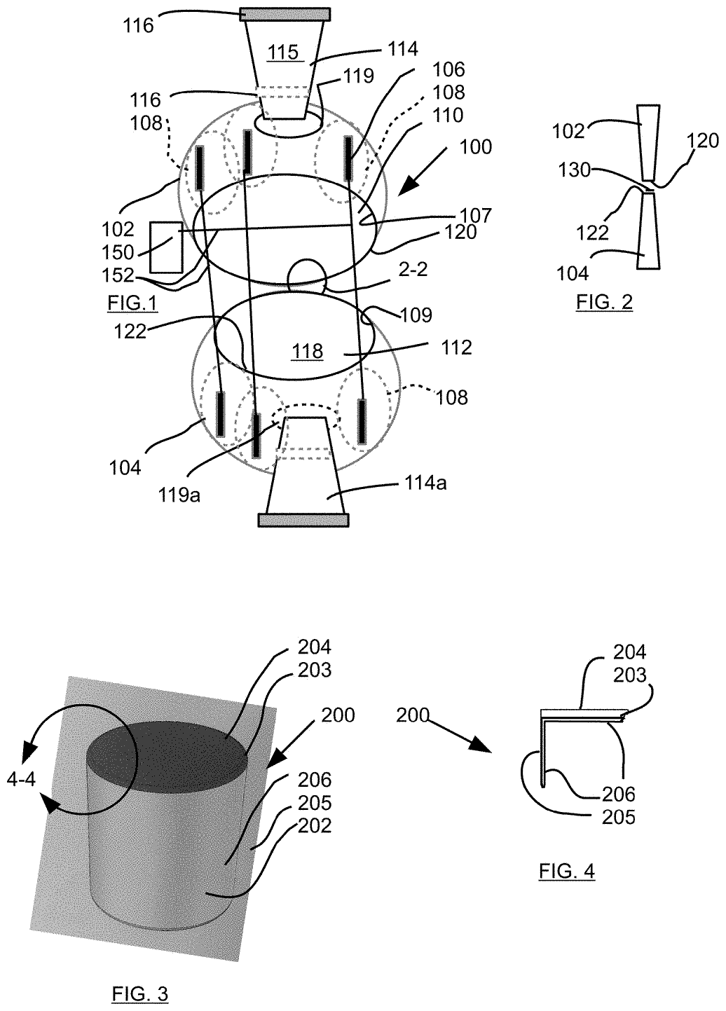

Referring to FIG. 2, first mating surface 120 bears against second mating surface 122. Insulator 130 may be disposed between first mating surface 120 and second mating surface 122. Insulator 130 may be a tape or sheet made of a polymer material such as Teflon® having heat insulating characteristics. The insulator 130 thermally isolates the first mold portion 102 from the second mold portion 104.

Referring to FIGS. 3-4, a two color molded furniture piece 200 may be formed by molding a first color 204 in mold 100 by preheating the first mold portion 102, providing a first color polymer to mold interior 118 after preheating first mold portion 102 to a predetermined temperature. Mold 100 may be closed and stepped through the first molding cycle. Next, the second mold portion 104 is preheated to a second predetermined temperature. When the second mold portion is at the desired temperature, the second color material 206 is inserted into the mold interior 118 and the mold is stepped through the second mold cycle.

Continuing to refer to FIGS. 1-4, the controller 150 may be adapted to control each temperature zone independently and may use heat zone control to create a heat profile in the mold 100 whereby first mold cavity 110 is heated to first predetermined temperature and second mold cavity 112 is insulated from contact with first mold cavity 110 by insulator 130 to prevent heat transfer across first mating surface 120 to second mating surface 122. First color 204 is dispensed into the mold interior and the mold rotated in two axis as standard roto-molding process. After a predetermined time, based on the particular polymer and respective temperatures used, controller 150 energizes one or more of the plurality of heater elements 106 in second mold portion 104. The second color 206 is dispensed into mold interior 118 for melting and adhering to mold interior walls 107, 109. Second drop box 114a may be similarly attached to second mold portion 104 for dispensing second color 206.

The two step drop box process comprises the steps of:

1. Assemble the mold 100 having the first mold portion 102 attached to the second portion 104 with insulator 130 there-between.

2. Mount drop box 114 on first drop box opening 119.

3. Place first color plastic material 204 in mold interior 118.

4. Seal second drop box opening 119a on second mold portion 104.

5. Place second color plastic material 206 in drop box 114, close lid 116.

6. Determine first and second rotation times.

7. Energize predetermined ones of the plurality of heating elements 106 on first mold portion 102 to heat first mold cavity 110 to a first predetermined temperature.

8. Rotate mold 100 in x and y planes urging plastic material to melt and coat first mold cavity 110 by melting the first color 204 and rotating for the predetermined first rotation time.

9. Pause a predetermined time having the first mold portion 102 oriented below second mold portion 104 above.

10. Energize ones of the plurality of heating elements 106 in second mold portion 104 to heat second mold portion 104 to a second predetermined temperature.

11. Dispense second plastic 206 into mold interior by opening drop box gate 116.

12. Close gate 116.

13. Rotate mold 100 in x and y planes for second rotation time.

14. De-energise heating elements 106.

15. Cool mold 100 by time or energizing cooling elements 106.

15. Disconnect first mold portion 102 from second mold portion 104.

16. Remove part.

It should be understood, a mold 100, having a plurality of portions 102, 104 may be used to create a device having several different colors or alternating colors formed by the single, multi step process of heating individual sections of the mold, exposing the heated sections to a plastic material and repeating until the device is fully formed.

A pixilated finish may be formed by a pixelating process by creating a mixture of a first granulated plastic material having a first color 204 and a second powered plastic 206 material having a second color. The pixilated finish comprises granuals partially melted on the mold cavity 110, 112 and finely ground or powdered plastic material 504 added to the mold cavity 110, 112 before the granulated material melts fully. The pixilated finish comprises granuals surrounded by finely ground plastic material wherein both are melted and formed together to give the look of stone or concrete. The pixilated finish may be achieved by the process of the following steps:

1. Assemble the mold 100 having the first mold portion 102 attached to the second mold portion 104 with insulator 130 there-between.

2. Mount drop box 114 on first drop box opening 119.

3. Mount second drop box 114a on second drop box opening 119a.

4. Energize respective ones of the plurality of heating elements 106 to heat first mold portion 102 to a predetermined temperature relative to the first color plastic 204.

5. Energize second ones of the plurality of heating elements 106 to heat second mold portion 104 to a predetermined temperature relative to the second color plastic 206.

6. Determine and set rotation time.

7. Place first color plastic 204 having a first granulated size in the mold interior 118.

8. Place second color plastic 206 having a powered granulation size in the mold interior 118.

9. Rotate mold 100 in x and y planes.

10. Rotate mold 100 in x and y planes for a predetermined time.

11. Cool mold 100 by de-energizing first and second heating elements 106.

12. Disconnect first mold portion 102 from second mold portion 104.

13. Remove part.

It should be understood, a one step pixelating process may be achieved without the use of the drop box. The large blobs of the first color plastic are formed by the granulated plastic pieces melting onto the mold cavity 110, 112. The gaps between granulated pieces is filled with the powered second plastic having a different color form the granulated plastic.

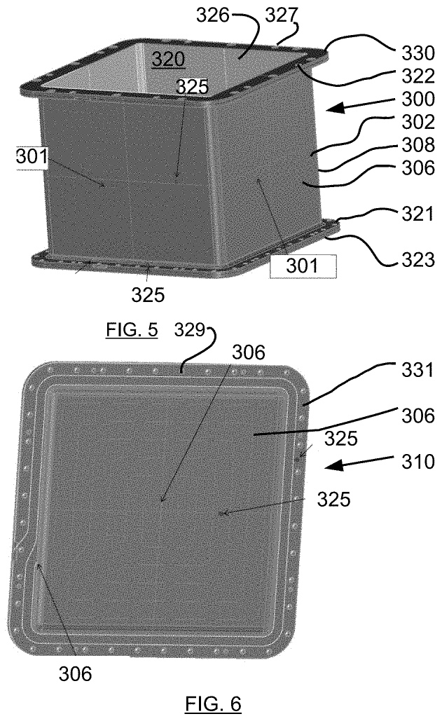

Referring to FIGS. 5-7, mold 300 comprises body 308, mold bottom 310 and mold top 312. Mold body 308 may comprise first body flange 322 to support and sealingly attach to mold top 312 and second body flange 321 adapted to sealingly attach to mold bottom 310. Mold body 308 may further comprise top insulator 330 on first body flange 322, a plurality of temperature sensors 325 on mold wall 301, a plurality of bolt holes 327 in first body flange 322 and second body flange 321 and a plurality of heater elements 306 disposed on mold wall 301. Mold cavity 320 is surrounded by mold body 308 and may comprise mold interior surface 326. Mold bottom 310 may comprise bottom flange 331 having a plurality of bolt holes 329 on bottom flange 331. Mold bottom 310 further comprises heater elements 306 and temperature sensors 325. Mold top 312 may further comprise top flange 340, temperature sensors 325 and heater elements 316 on mold top 312, bolt holes 329 in top flange 340 and a drop box opening 318 extending through mold top 312. Mold top 313 may further comprise logo port 336.

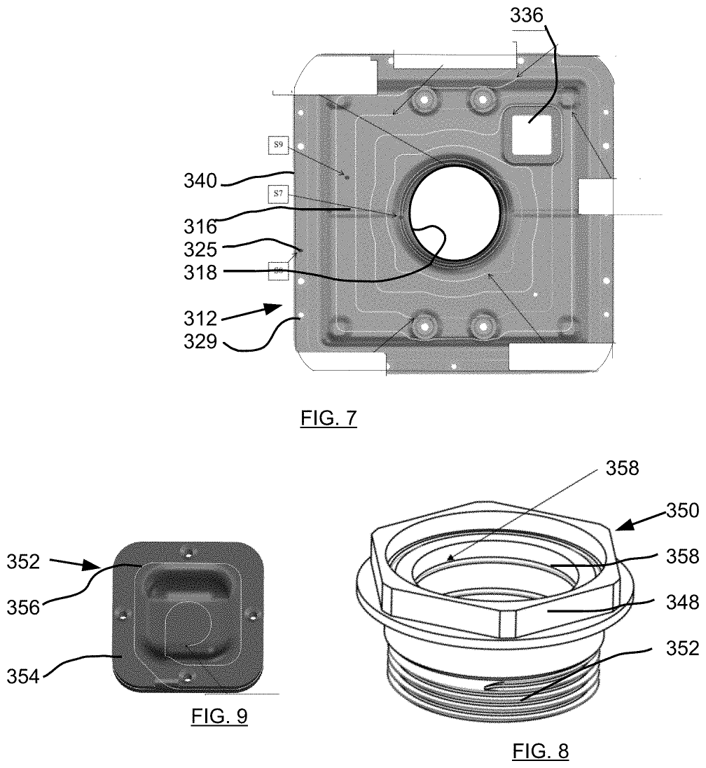

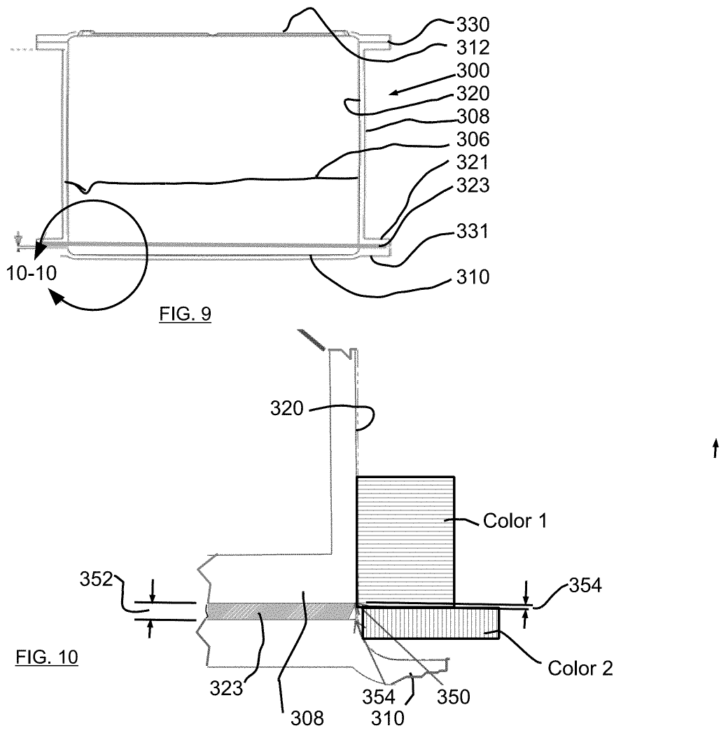

Referring to FIGS. 7-9, logo port 336 may be adapted to receive logo insert 352 therein. Logo insert 352 may further comprise insert heater element 356 disposed adjacent insert flange 354. Plug insert 350 may comprise threaded portion 350 for attaching to mold top 310, plug heater element 358 and grip 348. Drop box opening 318 may be occupied by plug insert 350.

Referring to FIG. 30-31, Mold insulator 323 is similar to mold insulator 330 and may be a polymer tape or strip. Mold insulator 323 may be disposed between second flange 321 and bottom flange 331 to thermally isolate mold portions 308, 310, and 312. Mold insulator 323 may comprise a thickness 352 that tapers to a point 350 having a smaller thickness 354 to minimize spacing 354 at the mold flange surfaces 321, 331 adjacent to while minimizing heat transfer between mold portions 308, 310.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

I claim:

1. A method of forming a two color molded part comprising:
Providing a mold having a first mold portion, a second mold portion, the first part comprising a first mating surface, the second mold portion comprising a second mating surface, the first mold portion comprising a heating element thereon, the second mold portion comprising a second heating element;
Providing a control adapted to control the heating element in the first mold portion;
attaching the first mold portion to the second mold portion to define a mold interior;
heating the first mold portion to a predetermined temperature;
placing a first plastic material in the mold interior;
rotating the mold for a predetermined time;
heating the second mold portion;
placing a second plastic material in the mold interior;
rotating the mold for a predetermined time;
open the mold by seperating the first mold portion from the second mold portion;
Removing the part.

2. the method of forming a two color molded part of claim 1 further comprising, providing a thermal isolator betweem the first mold portion and the second mold portion.
